(19) United States
(12) Patent Application Publication
(10) Pub. No.: US 2020/0314642 A1
(43) Pub. Date: Oct. 1, 2020

(54) LOCATION ANONYMIZATION SYSTEM

(71) Applicant: Uber Technologies, Inc., San Francisco, CA (US)

(72) Inventors: Houtan Shirani-Mehr, Santa Clara, CA (US); Kapil Gupta, Sunnyvale, CA (US); Susmit Biswas, San Mateo, CA (US)

(21) Appl. No.: 16/371,408

(22) Filed: Apr. 1, 2019

(51) Int. Cl. H04W 12/02; H04W 64/00; H04W 4/02; H04L 29/06

(52) U.S. Cl. CPC H04W 12/02; H04L 63/04; H04W 4/025; H04W 64/003

(57) ABSTRACT

Systems and methods are provided for generating a plurality of cells representing a geographical area, where each cell of the plurality of cells comprises a plurality of address points representing addresses in the cell, and normalizing each address corresponding to each address point into a hierarchical structure of address components. The systems and methods further provide for traversing a hierarchical structure of address components for address points in a first cell to determine address components that are different between address points in the first cell, and for each address component that is different between address points in the first cell, generating an anonymized address component using a common prefix for the address component or a combination of address components. An anonymized address is generated for the first cell comprising at least one anonymized address component, and the anonymized address is stored for the first cell.

### BACKGROUND

A user using a navigation service, a ride sharing service, or other service may need to provide a personal address that will be shared with operators of the service in order to complete the service. For example, in a ride sharing service a user's current location and a destination address is provided via a computing device of the user to a computing device of a driver and a computing system for the ride sharing service. The driver uses the user's location to navigate to the location to pick up the user and the destination address to navigate to the location to drop off the user at the desired destination. Moreover, the user's location and destination address may appear in a history of trips or navigation on the driver's computing device that is accessible by the driver after the ride.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is an example graphical user interface (GUI), according to some example embodiments.

FIG. 3 is flowchart illustrating aspects of a method, according to some example embodiments.

FIG. 4 illustrates an example geographical area partitioned into a plurality of quadrants, according to some example embodiments.

FIG. 5 illustrates a simple example of a hierarchy for address points in a geographical area, according to some example embodiments.

FIG. 6 illustrates a simple example of a hierarchical structure of address components for two address points in a first cell, according to some example embodiments.

FIG. 7 illustrates an example GUI, according to some example embodiments.

FIG. 8 is a block diagram illustrating an example of a software architecture that may be installed on a machine, according to some example embodiments.

FIG. 9 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

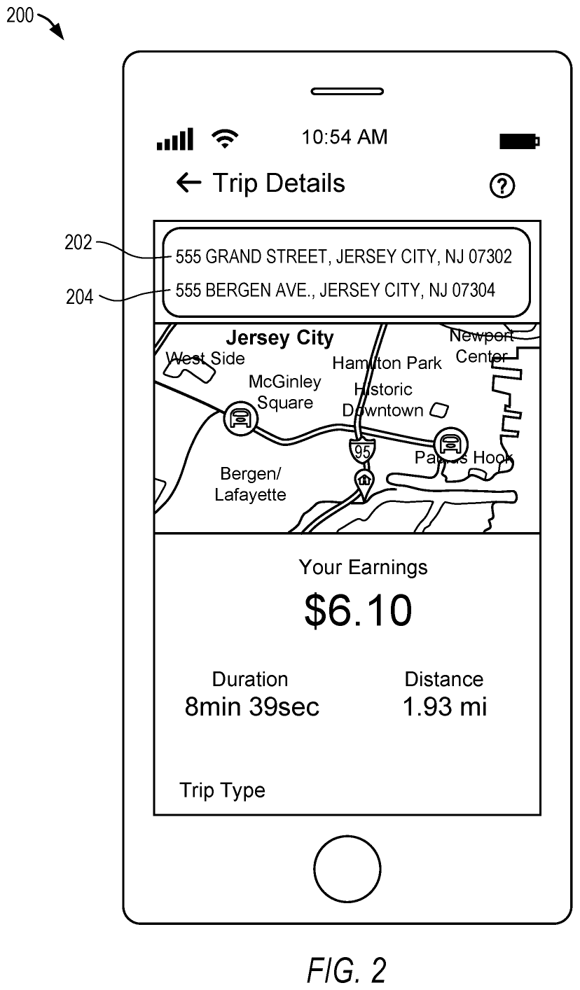

Systems and methods described herein relate to a location anonymization system. As explained above, a user may need to provide (e.g., via a computing device) location information, such as geographical coordinates, an address, a place name, and the like, to access a service such as a ride-sharing service or navigation service. The provided location information may be shared with other computing devices or systems. Another user may be able to access the provided location information via the computing devices or system. For example, a driver in a ride sharing server may be able to view a history of services such as trip details as shown in the example graphical user interface (GUI) 200 of FIG. 2. The trip details shown in GUI 200 include a start or pickup address 202 and a drop-off or destination address 204. As shown in this example, the rider's actual pickup and drop-off addresses are shown to the driver.

The user that provided the location information may not wish for his location information to be accessible by another user. For example, the user may not wish his home address to be accessible by a driver in a ride-sharing service for safety or privacy reasons. To address safety and privacy issues, example embodiments provide for a location anonymization system to generate an anonymized location. Example embodiments address privacy and safety issues of the user providing the location information, while at the same time not losing too much of utility of the address for another user (e.g., driver). For example, a computing system generates a plurality of cells representing a geographical area, where each cell of the plurality of cells comprises a plurality of address points representing addresses in the cell. The computing system normalizes each address corresponding to each address point into a hierarchical structure of address components and then traverses a hierarchical structure of address components for address points in each cell to determine address components that are different between address points in each cell. For each address component that is different between address points in each cell, the computing system generates an anonymized address component (e.g., using a common prefix for the address component or a combination of address components). The computing system generates an anonymized address for each cell comprising at least one anonymized address component and stores the anonymized address for each cell.

Example use cases described herein include navigation and ride sharing services (e.g., anonymizing start or pickup locations and drop-off or destination locations). It is to be understood that these are example use cases and that example embodiments may be used in other embodiments where an anonymized address or other location information is desired.

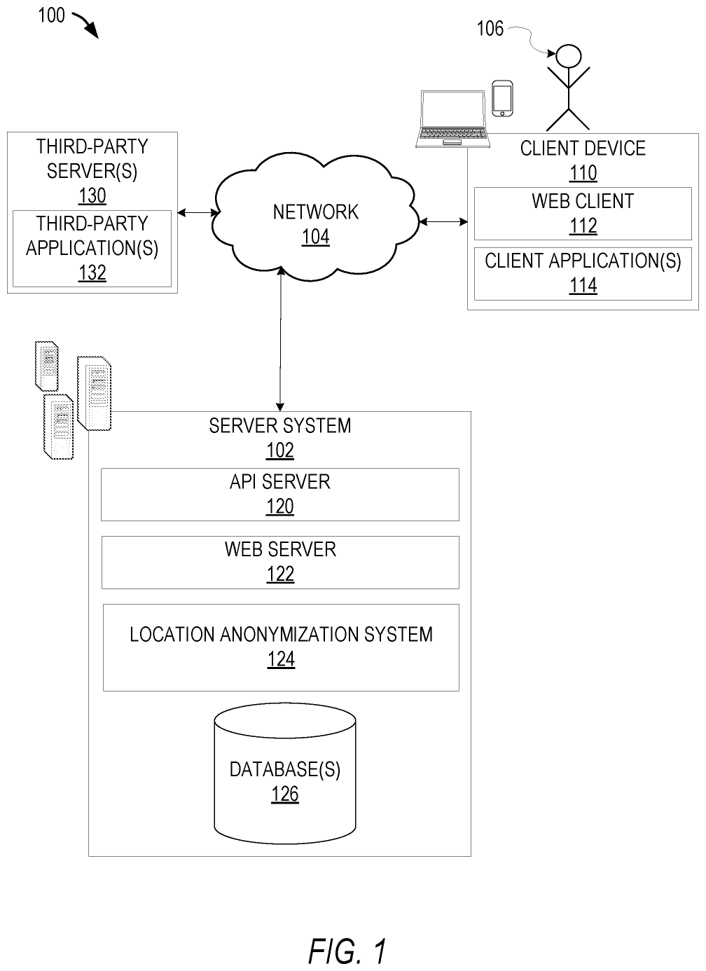

FIG. 1 is a block diagram illustrating a networked system 100, according to some example embodiments. The system 100 includes one or more client devices such as client device 110. The client device 110 may comprise, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touchscreens, accelerometers, gyroscopes, cameras, microphones, global positioning system (GPS) devices, and so forth. The client device 110 may be a device of a user that is used to request map information, provide map information, request navigation information, receive and display results of map and/or navigation information, request data about a place or entity in a particular location, receive and display data about a place or entity in a particular location, receive and display data about a pickup or drop-off location, receive and display data related to navigation to a pickup or drop-off location, and so forth.

One or more users 106 may be a person, a machine, or other means of interacting with the client device 110. In example embodiments, the user 106 is not be part of the system 100 but interacts with the system 100 via the client device 110 or other means. For instance, the user 106 provides input (e.g., touchscreen input or alphanumeric input) to the client device 110 and the input may be communicated to other entities in the system 100 (e.g., third-party servers 130, server system 102) via a network 104. In this instance, the other entities in the system 100, in response to receiving the input from the user 106, communicate information to the client device 110 via the network 104 to be presented to the user 106. In this way, the user 106 interacts with the various entities in the system 100 using the client device 110. In some example embodiments, a user 106 is a rider in a ride-sharing service, a driver in a ride-sharing service, or a person desiring information about safety of a location.

The system 100 further includes the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 accesses the various data and applications provided by other entities in the system 100 via a web client 112 (e.g., a browser, such as the Internet Explorer browser developed by Microsoft Corporation of Redmond, Wash. State) or one or more client applications 114. The client device 110 includes the one or more client applications 114 (also referred to as “apps”) such as, but not limited to, a web browser, messaging application, electronic mail (email) application, an e-commerce site application, a mapping or location application, a ride sharing application, and the like.

In some embodiments, the one or more client applications 114 may be included in the client device 110, and configured to locally provide a user interface and at least some of the functionalities, with the client applications 114 configured to communicate with other components or entities in the system 100 (e.g., third-party servers 130, server system 102), on an as-needed basis, for data and/or processing capabilities not locally available (e.g., access location information, request a pickup or drop-off location, access navigation information, to authenticate the user 106, to verify a method of payment, etc.). Conversely, the one or more applications 114 may not be included in the client device 110, and the client device 110 uses its web browser to access the one or more applications hosted on other entities in the system 100 (e.g., third-party servers 130, server system 102).

The server system 102 provides server-side functionality via the network 104 (e.g., the Internet or wide area network (WAN)) to one or more third-party servers 130 and/or one or more client devices 110. The server system 102 may include an application program interface (API) server 120, a web server 122, and location anonymization system 124, that are communicatively coupled with one or more databases 126.

The one or more databases 126 are storage devices that store data related to one or more of source code, machine learning model training data, image data (including extracted text from images), place or other mapping data, candidate pickup and drop-off locations, navigation data, hierarchical structure of address components for addresses, anonymized addresses, and so forth. The one or more databases 126 may further store information related to the third-party servers 130, third-party applications 132, the client device 110, the client applications 114, the user 106, and so forth. The one or more databases 126 may be cloud-based storage.

The server system 102 is a cloud computing environment, according to some example embodiments. The server system 102, and any servers associated with the server system 102, are associated with a cloud-based application, in one example embodiment.

The location anonymization system 124 provides back-end support for the third-party applications 132 and the client applications 114, which may include cloud-based applications. The location anonymization system 124 generates anonymized address components, addresses, and so forth as described in further detail below. The location anonymization system 124 comprises one or more servers or other computing devices or systems.

The system 100 further includes one or more third-party servers 130. The one or more third-party servers 130 comprise one or more third-party application(s) 132. The one or more third-party application(s) 132, executing on the third-party server(s) 130, interact with the server system 102 via a programmatic interface provided by the API server 120. For example, the one or more the third-party applications 132 may request and utilize information from the server system 102 via the API server 120 to support one or more features or functions on a website hosted by a third party or an application hosted by the third party.

Example embodiments k-anonymize a location, such as an address. A set of addresses has a k-anonymity property if an address is distinguishable from at least k−1 other addresses. Example embodiments comprise a hierarchical address anonymization approach to achieve k-anonymization. For example, partitioning technologies, such as Quadtree or distribution grid, are leveraged to hierarchically index a set of addresses and thereafter anonymize each of the Quadtree or other type of partitions (otherwise referred to herein as “cells”) and use the anonymized partitions or cells to provide to computing devices for displaying anonymized location information to a driver or other user. In example embodiments, the anonymization of each of the partitions or cells is accomplished by leveraging the hierarchical structure of the addresses and hiding or modifying as few address components as possible to achieve the desired level of privacy, as explained in further detail below.

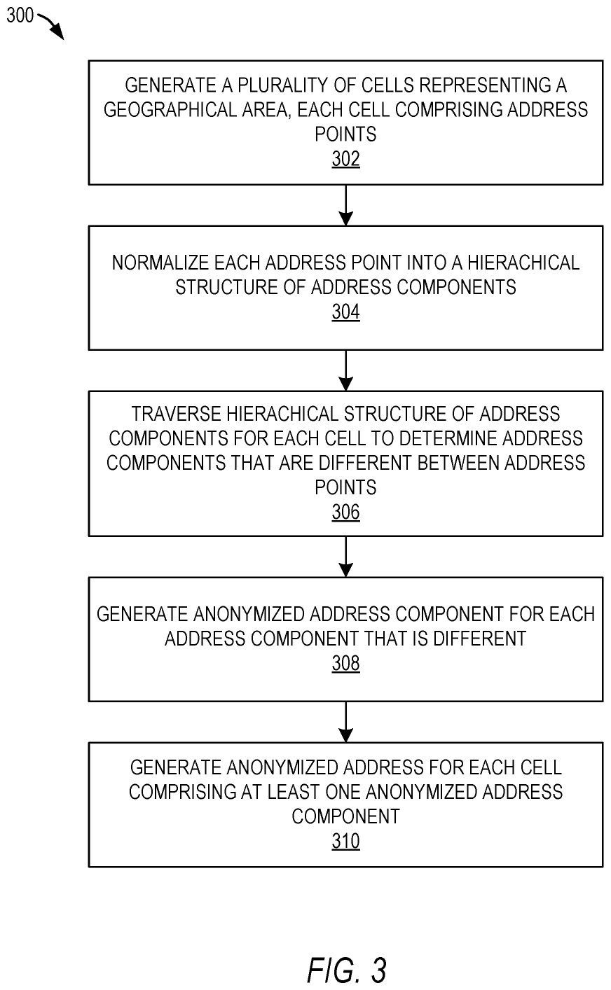

FIG. 3 is a flow chart illustrating aspects of a method 300 for generating an anonymized address, according to some example embodiments. For illustrative purposes, the method 300 is described with respect to the networked system 100 of FIG. 1. It is to be understood that the method 300 may be practiced with other system configurations in other embodiments.

In operation 302, one or more processors of a computing system (e.g., a server system, such as the server system 102 or the location anonymization system 124), generates a plurality of cells representing a geographical area. In one example, each cell of the plurality of cells comprises a plurality of address points representing addresses in the cell.

In one example, generating the plurality of cells representing the geographical area comprises partitioning the geographical area into a predefined or predetermined number (e.g., four) equal sized cells and then recursively partitioning each cell into the predefined or predetermined number (e.g., four) equal sized cells until a specified size of a cell is reached or until a number of address points in the cell reaches a predefined number. For example, an address space or geographical area can be partitioned by a Quadtree. Quadtree is one example method of partitioning and indexing special objects. Other space partitioning approaches can be used in other example embodiments (e.g., grid or distribution grid).

In the Quadtree approach, a spatial set of objects are partitioned into four quadrants (also referred to herein as “partitions” or “cells”). Afterward, each quadrant is recursively partitioned into four equal size quadrants. Recursive partitioning of a quadrant is stopped if the density of the objects in a quadrant is small enough. In example embodiments, Quadtree is used to partition the address space in a geographical area. The geographical area can be the entire world, or a smaller area, such as a continent, country, state, city, or other area. The recursive partitioning of a quadrant is stopped if the number of addresses in that quadrant is less than n, or a quadrant is small enough (e.g., a quadrant size is 0.5). The value of n can be the same as k (for k-anonymity, as explained above) or smaller than k. For example, the value of n and k are chosen (predetermined) based on a degree of anonymization needed or desired.

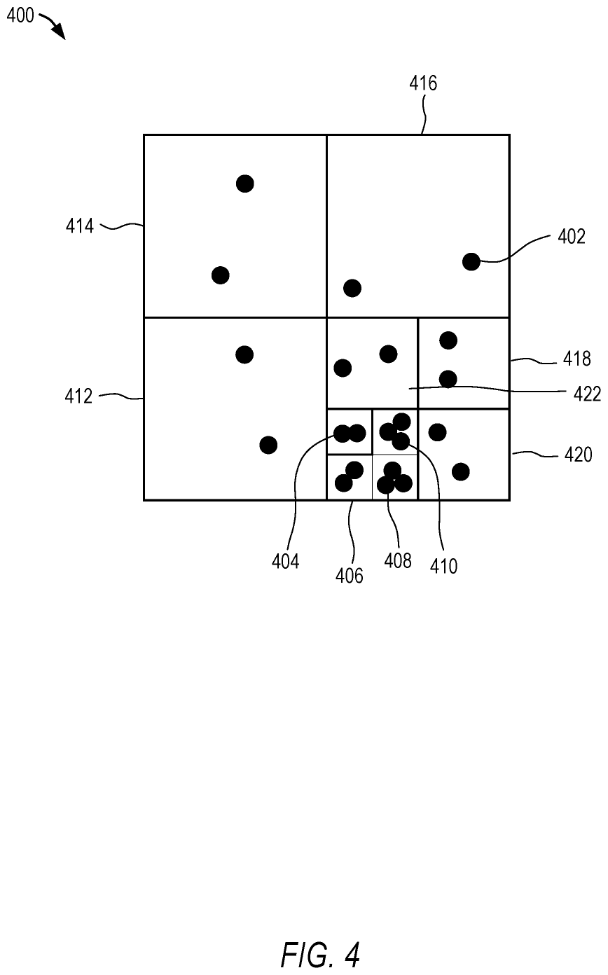

FIG. 4 illustrates an example quadtree 400 which partitions the address space or geographical area into a plurality of quadrants or cells 404-422. Each of the dots in the quadrants represent an address point, such as address point 402. In this example, the value of n (e.g., the predefined number of address points) is selected as 2. As can be seen in this example, some quadrants have more than 2 address points since the recursive partitioning of the quadrant is stopped when the quadrant reaches a specified (e.g., minimum) size. For example, the specified size can be a minimum size such as 0.25 miles, 0.5 miles, or other size. As can be seen in the example quadtree 400, the quadrants (or cells) 404-410 have more than 2 address points since they have reached a specified minimum size.

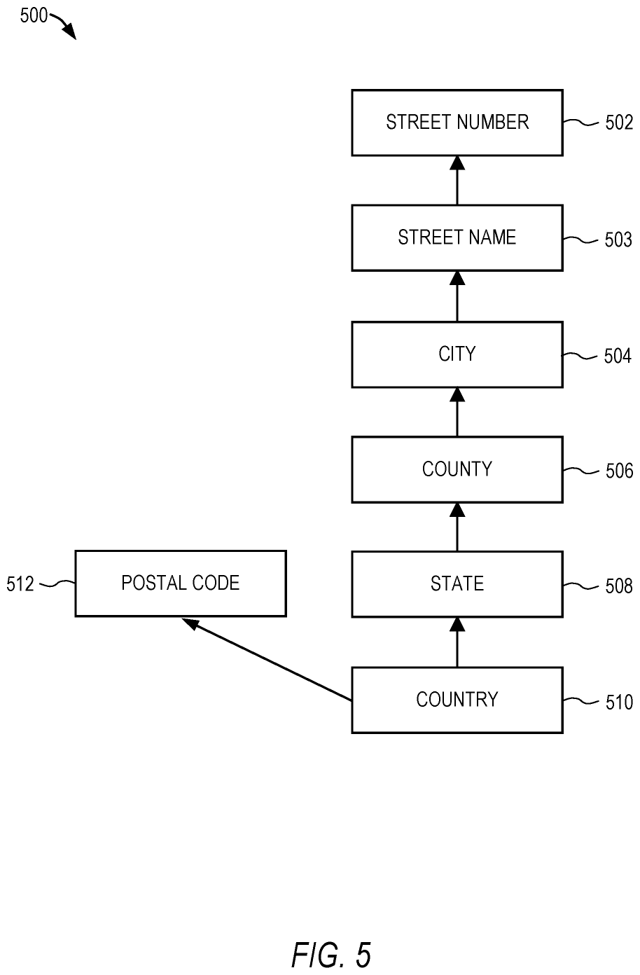

Returning to FIG. 3, in operation 304, the one or more processors of the computing system normalizes each address corresponding to each address point (e.g., in the plurality of cells representing the geographical area) into a hierarchical structure of address components. For example, each address point in a geographical area, such as a country, will be parsed and normalized to have a hierarchical structure. FIG. 5 illustrates a simple example of a hierarchy 500 for address points in the United States. The hierarchy 500 comprises address components 502-512 based on the structure of addresses in the United States. It is to be understood that a different hierarchy may be used for each geographical area (e.g., country, state, city, etc.) since each geographical area typically has a unique address structure. For example, each country may have a different address structure, a country might have more than one address structure within the country, and so forth. For such cases, the quad tree cell should be small enough to cover only one address structure. In the example in FIG. 5, the root address component of the hierarchy 500 is a country address component 510. In other examples the root address component can be the state address component 508 or other address component.

Returning to FIG. 3, in operation 306, the one or more processors of the computing system traverses the hierarchical structure of address components for address points in each cell to determine address components that are different between address points in each cell. For example, the computing system traverses a hierarchical structure of address components for address points in a first cell to determine address components that are different between address points in the first cell.

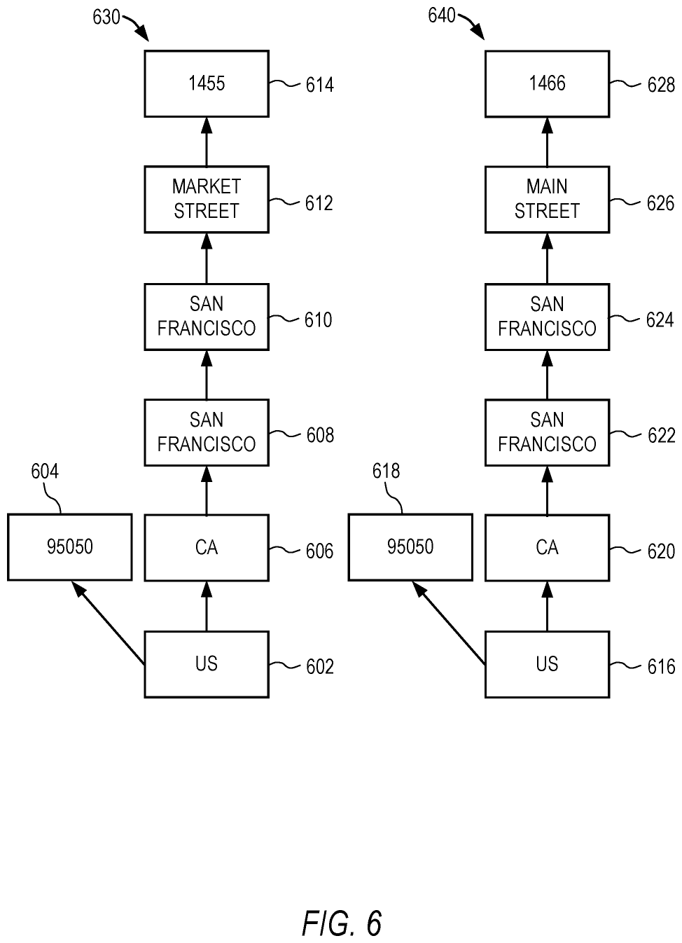

For instance, FIG. 6 illustrates a simple example of a hierarchical structure of address components for two address points 630 and 640, that are in a first cell. The hierarchical structure of address components for address point 630 comprises address components 602-614 and the hierarchical structure of address components for address point 640 comprises address components 616-628. In this example, the computing system starts at a root address component (e.g., country address component 510) and compares the root address components 602 and 616 for each of the address points 630 and 640 in a first cell to determine whether any of the root address components differ between the address points in the first cell. In this case, the root address components 602 and 616 are the same (US) and thus do not need to be anonymized. The computing system moves to the next address component (e.g., state address component 508), which includes address components 606 and 620, and continues this way until address components differ between address points 630 and 640. In this example, the first address components that differ are the street address components 612 and 626. For example, address component 612 is “Market Street” while address component 626 is “Main Street.” The second address components that are different in this example are the street number address component 614 and 628. For example, address component 614 is “1455” and address component 628 is “1466.” The computing system traverses the hierarchy to cover all of the address components.

For each address component that is different between address points in the first cell (or in each cell), the computing system generates an anonymized address component, in operation 308 of FIG. 3. For example, the computing system generates an anonymized address component using a common prefix for the address component, a combination of address components, a nearby intersection, or other method.

To generate the anonymized address component using the common prefix for the address component, the computing system first determines whether there is a common prefix. For example, the address components “Market Street” and “Main Street” both start with “Ma,” and thus, “Ma” is the common prefix for the street address component. In one example, the computing system replaces the characters after the common prefix with one or more predefined characters to generate the anonymized address component. For example, the computing system may replace the characters after “Ma” with a “*” so that the street name becomes “Ma*” as the anonymized address component.

In another example, the address components “1455” and “1466” have a common prefix “14.” In this example, the computing device replaces the characters after the “14” with one or more predefined characters, for example “14**”. In another example, a street number can be represented with a range of numbers as the predefined characters. For example, “14[00-99].” The number range can be based on the range of street numbers in the cell, for example.

If the computing system determines that there is no common prefix for the address component, the computing device may use a combination of address components. For example, if a street name component for a first address point is “Market” and a street name component for a second address point is “Brand,” there is no common prefix for these street names. In this example, the address components can be combined to generate the anonymized address component. For example, “Market Street and Brand Street” or “Around Market Street and Brand Street” or “Near Market Street and Brand Street” or the like. This may work well if there are only two address points or only two distinct street names in a cell. In another example, an intersection in the cell can be used to generate the anonymized address component. For example, the computing system can determine an intersection in the cell representing street names corresponding to at least two address points, choose a random intersection in the cell, choose a popular or common intersection in the cell, or the like. The computing system can then generate the anonymized address component for the address component using the intersection (e.g., “near the intersection of Market Street and Brand Street”).

Returning to FIG. 3, the one or more processors of the computing system generates an anonymized address for the first cell comprising at least one anonymized component, in operation 310. For example, the computing system generates an anonymized address with the address components that are the same between address points and one or more anonymized address components for the address components that are different between the address points. Using the above examples, any of the following examples can be used as the representative address of a cell:

“14[00-99], between Market and Brand Street, San Francisco, Calif. 95050, US”

### “14[00-99], Ma* Street, San Francisco, Calif. 95050, US”

### “14*, Ma* Street, San Francisco, Calif. 95050, US”

In one example, the computing system stores the anonymized address for the first cell (and for each cell) in one or more data stores (e.g., databases 126). In one example, the count of the address points in the cell is also stored.

The anonymized addresses can be used to respond to requests for address or location information. In one example, the computing system receives, from a computing device (e.g., client device 110 or third-party server 130) a request for an address of a location. The request can include geographical coordinates (e.g., latitude and longitude of an address) for the location. The computing system determines a cell of the plurality of cells for the geographical area that comprises the geographical coordinates for the location. The computing system determines the anonymized address for the cell and provides the anonymized address to the computing device as the address of the location (e.g., “14*, Ma* Street, San Francisco, Calif. 95050, US”). For example, the computing system can access one or more data stores to determine the cell and the anonymized address for the cell and then send the anonymized address to the computing device. The computing system or device can cause the anonymized address to be displayed to a user or use the anonymized address for other purposes.

In one example, in determining the anonymized address for the cell, the computing system first determines the number of address points of the cell (e.g., based on the stored count of address points for the cell). If the number of address points in the cell is greater than or equal to a specified number of address points (e.g., more than k address points), then the computing system retrieves the generated anonymized address for the cell and provides it to the computing device, as described above. In this case, the representative address generated during preprocessing for the cell is returned. If the number of address points in the cell is less than a specified number of address points (e.g., less than k address points), then the computing system generates an updated anonymized address for the cell using neighboring cells such that eventually the address becomes indistinguishable from at least k−1 other addresses, as described above with respect to FIG. 3. For example, k may be 10 and the number of address points for a cell is 2. In this case, the computing system generates an updated anonymized address using the neighboring cells until the number of address points is greater than or equal to 10.

For example, to generate the updated anonymized address for the cell, the computing system traverses a hierarchical structure of address components for address points of selected cells comprising the cell and each cell neighboring the cell to determine address components that are different between address points in the selected cells. In one example, a cell neighboring the cell is a cell that is next to the cell (e.g., a cell on top of a given cell, a cell on the bottom of the given cell, a cell to the left of the given cell, or a cell to the right of the given cell). For each address component that is different between address points in the selected cells, the computing system generates an anonymized address component using a common prefix for the address component or a combination of address components, or other method as described above. The computing system generates the updated anonymized address for the cell comprising one or more anonymized address components and provides the updated anonymized address for the cell to the computing device.

In one example, an address structure may comprise two parts: a place name (e.g., a point of interest) and a location address. A place name or a point of interest may comprise a name of a place at the location address. For example, Joe's café, Memorial Park, Hillside Apartments, San Francisco International Airport, and so forth. In one embodiment, the computing system removes the place name in addition to the above describe anonymization of the location address. In another embodiment, the computing system first determines whether the place name is a popular or common place (e.g., based on unique visits as explained below or based on whether it is a public place versus a private or residential place) and only removes the removes the place name if the place name is not a popular or common place. For example, if the place name is the name of an apartment building, the place name may be removed. If, however, the place name is a name of an airport, the place name may not be removed. In the latter case (where the place name is not removed) the place name may be also provided with the anonymized address in response to a request for location.

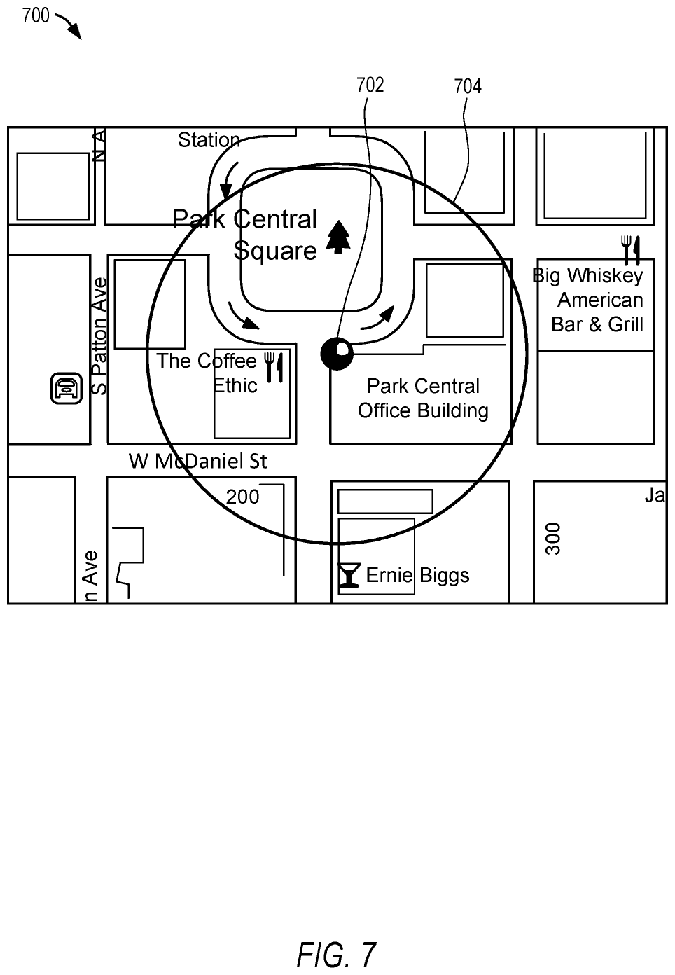

In addition to anonymizing the address, example embodiments provide for the actual corresponding location of the address (e.g., the geographical coordinates, such as the latitude and longitude of the address) to also be anonymized. For example, if a location is shown as a point on a map, a user can zoom into the map to see the exact location of the point, and thus know the actual address. Multiple approaches can be used to anonymize the location of the address. For example, one approach is to set the location of the address away from the original location and display a range of locations instead of just a point. For example, a circle can be created around a point away from the original location to indicate a general area for the location, as shown in the display 700 of FIG. 7. For example, the display 700 includes a point 702 in the center of a circle 704. To generate such a display, the computing system determines a point for the center of the circle and a radius for the size of the circle.

For example, the computing device determines the geographical coordinates of a specified location (e.g., received from a computing device, determined from an address). In one example, the center of the circle is determined by applying differential privacy where a random noise is added to the geographical coordinates to make the geographical coordinates of the specified location fuzzy. A predefined radius is then used as the circle surrounding the fuzzy location. The fuzzy location and the predefined radius is provided to a computing device so the point and circle can be displayed on the computing device.

In another example, the computing system determines a cell comprising the geographical coordinates and then uses the anonymized address of the cell as the center point and the size of the cell, or other predefined size, as the size of the radius. The computing system provides the anonymized address to the computing device to be displayed on the computing device as the specified address within a circle corresponding to the size of the cell (or other predefined size). In the case where multiple neighboring cells are merged to generate the final anonymized address, either the original cell can be used to set the center point (e.g., a center of the original cell), or the original cell or one of the neighboring cells could be randomly selected to set the center point (e.g., a center of the randomly selected cell), and then the size of the original cell or randomly selected cell (or other predefined sized) can be used as the size of the radius.

In another example, the computing system using the range of street numbers from the anonymized address to determine a circle center and radius. For example, the center point can be the center of the range of addresses and the radius can be of a size to cover the range or addresses, or other predefined size.

In another example, the computing system determines a cell comprising the geographical coordinates and then selects a center point within the cell as the center point for the circle and the size of the cell (or other predefined size) as the radius for the circle. The computing system provides the center point location to the computing device to be displayed on the computing device as the specified address within a circle corresponding to the size of the cell (or other predefined size). In the case where multiple neighboring cells are merged to generate the final anonymized address, either the original cell can be used to set the center point (e.g., a center of the original cell), or the original cell or one of the neighboring cells could be randomly selected to set the center point (e.g., a center of the randomly selected cell), and then the size of the original cell or randomly selected cell (or other predefined sized) can be used as the size of the radius.

In another example, the computing system determines a cell comprising the geographical coordinates and then selects a random point within the cell as the center point for the circle and the size of the cell (or other predefined size) as the radius for the circle. The computing system provides the center point (e.g., random point) location to the computing device to be displayed on the computing device as the specified address within a circle corresponding to the size of the cell (or other predefined size). In the case where multiple neighboring cells are merged to generate the final anonymized address, either the original cell can be used to set the center point (e.g., a random point within the original cell), or the original cell or one of the neighboring cells could be randomly selected to set the center point (e.g., a random point within the randomly selected cell), and then the size of the original cell or randomly selected cell (or other predefined sized) can be used as the size of the radius.

In another example, the computing system replaces the area of the geographical coordinates of the specified area with a large area. In this example, the larger area would be the area represented by the anonymized address. For example, if the anonymized address is “14[00-99] Market St, San Francisco, Calif. 95050, USA”, the radius would be selected in a way that covers the addresses in the range of 1400 to 1499 on Market Street. This information would be provided to the computing device to be displayed on the computing device.

With any approach used to anonymize the geographical coordinates or location of the address, the new anonymized location (e.g., latitude and longitude of the address) should be selected such that it does not give any information on the exact address. For example, assume the anonymized address is “14[00-99] Market St, San Francisco, Calif. 95050, USA”. In this example, a circle is shown on a GUI as the possible location of the address, and the radius of the circle is selected in such a way as to cover all the anonymized addresses in the range of 1400 to 1499 Market St, San Francisco, Calif. 95050, USA.

In some examples, other factors can be considered in determining whether there is a need to anonymize an address or geographical coordinates corresponding to an address. For example, an address point can be classified into different category types. For instance, an address point may be a home address, a large shopping mall, an airport, a point of interest (e.g., café, mall, park, etc.), or the like. For some category types, it may not be necessary to anonymize the address. For instance, a public address like a shopping mall can be presented to a user (e.g., a driver) without any anonymization since there is less need for safety or privacy for such a public and large location. One way to achieve this is to store an address type associated with an address. For example, the address type may be “public” or “private.” If the computing system determines that an address type for an address is “public,” the computing system does not need to generate an anonymized address for the address.

In another example, the computing device can generate a number of unique users visiting a particular address point over a period of time to determine the need for anonymization of the address point. For example, if an address is visited over a predefined number of times by unique visitors (e.g., like an airport) over a period of time (e.g., a week), there is no need to anonymize the address since the number of visits indicates that the address is a popular public space. Thus, if the computing system determines that the number of unique users visiting a particular address is greater than a predetermined threshold, the computing system does not generate an anonymized address for the particular address.

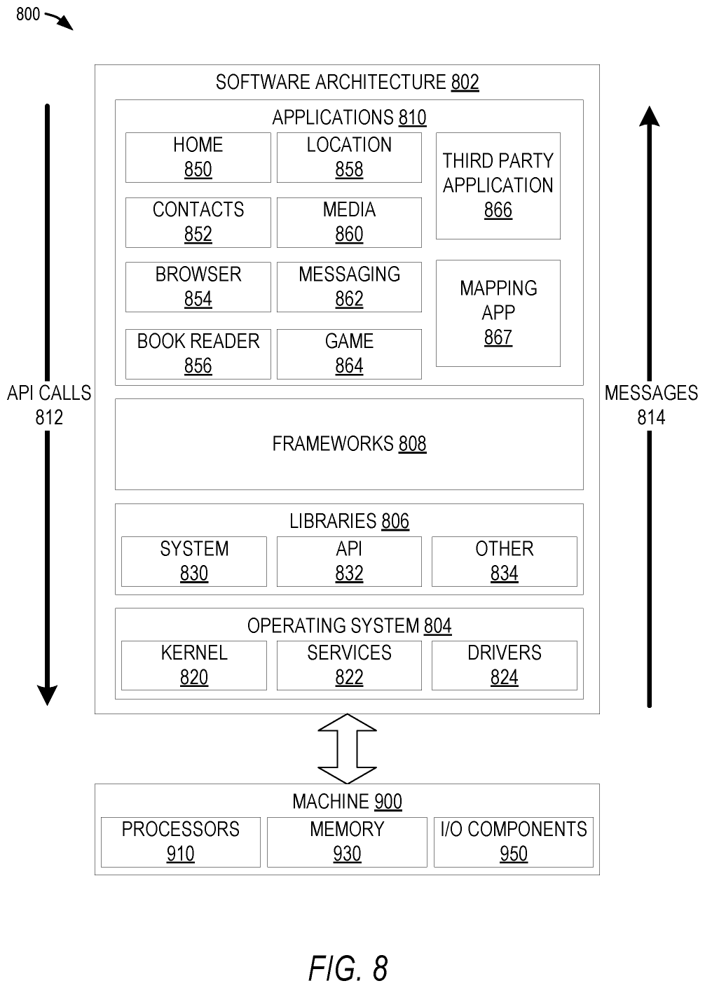

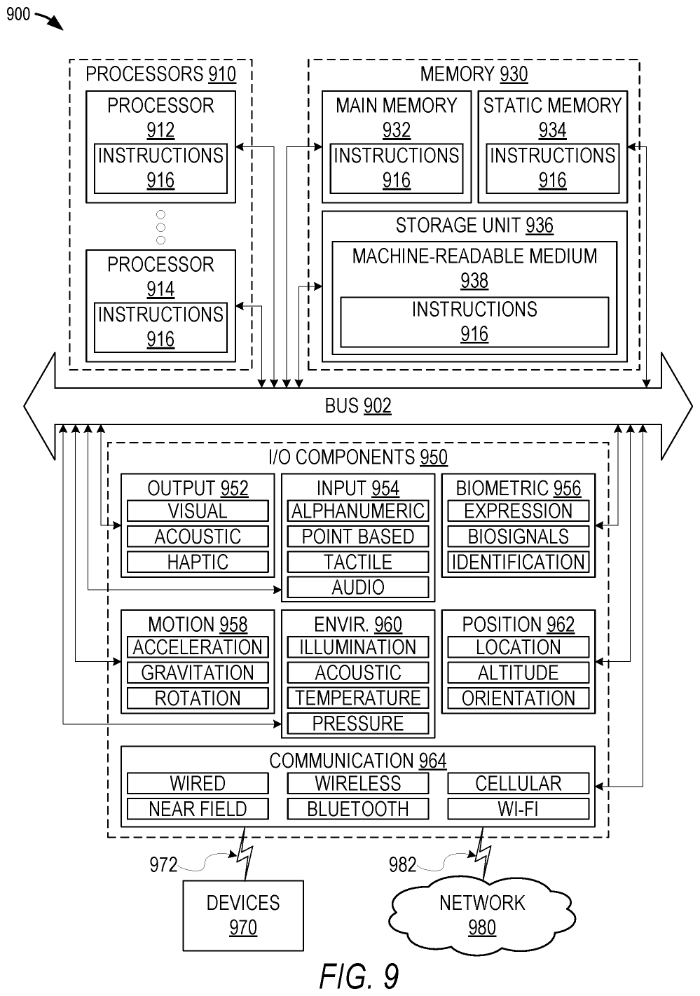

FIG. 8 is a block diagram 800 illustrating software architecture 802, which can be installed on any one or more of the devices described above. For example, in various embodiments, client devices 110 and servers and systems 130, 102, 120, 122, and 124 may be implemented using some or all of the elements of software architecture 802. FIG. 8 is merely a non-limiting example of a software architecture, and it will be appreciated that many other architectures can be implemented to facilitate the functionality described herein. In various embodiments, the software architecture 802 is implemented by hardware such as machine 900 of FIG. 9 that includes processors 910, memory 930, and I/O components 950. In this example, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematical functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphic user interface (GUI) functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

Some embodiments may particularly include a mapping application 867. In certain embodiments, this may be a stand-alone application that operates to manage communications with a server system such as third-party servers 130 or server system 102. In other embodiments, this functionality may be integrated with another application. The mapping application 867 may request and display various data related to mapping and navigation and may provide the capability for a user 106 to input data related to the objects via a touch interface, keyboard, or using a camera device of machine 900, communication with a server system via I/O components 950, and receipt and storage of object data in memory 930.

Presentation of information and user inputs associated with the information may be managed by mapping application 867 using different frameworks 808, library 806 elements, or operating system 804 elements operating on a machine 900.

FIG. 9 is a block diagram illustrating components of a machine 900, according to some embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application 810, an applet, an app, or other executable code) for causing the machine 900 to perform any one or more of the methodologies discussed herein can be executed. In alternative embodiments, the machine 900 operates as a standalone device or can be coupled (e.g., networked) to other machines. In a networked deployment, the machine 900 may operate in the capacity of a server machine or system 130, 102, 120, 122, 124, etc., or a client device 110 in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term “processor” is intended to include multi-core processors 910 that may comprise two or more independent processors 912, 914 (also referred to as “cores”) that can execute instructions 916 contemporaneously. Although FIG. 9 shows multiple processors 910, the machine 900 may include a single processor 910 with a single core, a single processor 910 with multiple cores (e.g., a multi-core processor 910), multiple processors 912, 914 with a single core, multiple processors 912, 914 with multiples cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 include output components 952 and input components 954. The output components 952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touchscreen that provides location and force of touches or touch gestures, or other tactile input components), audio input components (e.g., a microphone), and the like.

In some further example embodiments, the I/O components 950 include biometric components 956, motion components 958, environmental components 960, or position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or another suitable device to interface with the network 980. In further examples, communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D barcodes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (in other words, not having any transitory signals) in that it does not embody a propagating signal. However, labeling the machine-readable medium 938 “non-transitory” should not be construed to mean that the medium is incapable of movement; the medium 938 should be considered as being transportable from one physical location to another. Additionally, since the machine-readable medium 938 is tangible, the medium 938 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
generating, using one or more hardware processors, a plurality of cells representing a geographical area, each cell of the plurality of cells comprising a plurality of address points representing addresses in the cell;
normalizing, using the one or more hardware processors, each address corresponding to each address point into a hierarchical structure of address components;
traversing, using the one or more hardware processors, a hierarchical structure of address components for address points in a first cell of the plurality of cells to determine address components that are different between address points in the first cell;
for each address component that is different between address points in the first cell, generating, using the one or more hardware processors, an anonymized address component using a common prefix for the address component or a combination of address components;
generating, using the one or more hardware processors, an anonymized address for the first cell comprising at least one anonymized address component; and
storing, using the one or more hardware processors, the anonymized address for the first cell to a data storage.

2. The method of claim 1, wherein generating the plurality of cells representing the geographical area comprises:
partitioning the geographical area into a predetermined number of equal sized cells; and
recursively partitioning each cell into the predetermined number of equal sized cells until a specified size of a cell is reached or until a number of address points in the cell reaches a predefined number.

3. The method of claim 1, wherein generating the anonymized address component using the common prefix for the address component comprises:
determining the common prefix for the address component; and
replacing characters after the common prefix with one or more predefined characters to generate the anonymized address component.

4. The method of claim 1, wherein generating the anonymized address component using a combination of address components comprises:
determining that there is no common prefix for the address component;
determining an intersection in the cell representing street names corresponding to at least two address points; and
generating the anonymized component for the address component using the intersection in the cell.

5. The method of claim 1, further comprising:
receiving, from a computing device, a request for an address of a location;
determining a first cell of the plurality of cells that comprises the location;
determining, from the data storage, an anonymized address for the first cell; and
providing the anonymized address for the first cell to the computing device as the address of the location.

6. The method of claim 5, wherein determining the anonymized address for the first cell comprises:
determining that a number of address points in the first cell is greater than or equal to a specified number of address points; and
in response to determining that a number of address points in the first cell is greater than or equal to a specified number of address points, retrieving, from the data storage, the generated anonymized address for the first cell.

7. The method of claim 5, wherein determining the anonymized address for the first cell comprises:
determining that the number of address points in the first cell is less than a specified number of address points; and
generating an updated anonymized address for the first cell, the generating the updated anonymized address comprising:
traversing the hierarchical structure of address components for address points of selected cells comprising the first cell and each cell neighboring the first cell to determine address components that are different between address points in the selected cells;
for each address component that is different between address points in the selected cells, generating an anonymized address component using a common prefix for the address component or a combination of address components;
generating the updated anonymized address for the first cell comprising at least one anonymized address component; and
wherein providing the anonymized address for the first cell to the computing device as the address of the location comprises providing the updated anonymized address.

8. The method of claim 1, further comprising:
determining geographical coordinates for a specified location;
determining that the first cell comprises the geographical coordinates;
providing, to a computing device, an anonymized address of the first cell to be displayed on the computing device as the specified location within a circle corresponding to a size of the first cell.

9. The method of claim 1, further comprising:
determining geographical coordinates for a specified location;
determining that the first cell comprises the geographical coordinates;
selecting a center point within the first cell; and
providing, to a computing device, the location of the center point within the cell to be displayed on the computing device as the specified location within a circle corresponding to a size of the first cell.

10. A computing system comprising:
a memory that stores instructions; and
one or more processors configured by the instructions to perform operations comprising:
generating a plurality of cells representing a geographical area, each cell of the plurality of cells comprising a plurality of address points representing addresses in the cell;
normalizing each address corresponding to each address point into a hierarchical structure of address components;
traversing a hierarchical structure of address components for address points in a first cell of the plurality of cells to determine address components that are different between address points in the first cell;
for each address component that is different between address points in the first cell, generating an anonymized address component using a common prefix for the address component or a combination of address components;
generating an anonymized address for the first cell comprising at least one anonymized address component; and
storing the anonymized address for the first cell to a data storage.

11. The system of claim 10, wherein generating the plurality of cells representing the geographical area, comprises:
partitioning the geographical area into a predetermined number of equal sized cells; and
recursively partitioning each cell into a predetermined number of equal sized cells until a specified size of a cell is reached or until a number of address points in the cell reaches a predefined number.

12. The system of claim 10, wherein generating the anonymized address component using the common prefix for the address component comprises:
determining the common prefix for the address component; and
replacing characters after the common prefix with one or more predefined characters to generate the anonymized address component.

13. The system of claim 10, wherein generating the anonymized address component using a combination of address components comprises:
determining that there is no common prefix for the address component;
determining an intersection in the cell representing street names corresponding to at least two address points; and
generating the anonymized component for the address component using the intersection in the cell.

14. The system of claim 10, the operations further comprising:
receiving, from a computing device, a request for an address of a location;
determining a first cell of the plurality of cells that comprises the location;
determining an anonymized address for the first cell; and
providing the anonymized address for the first cell to the computing device as the address of the location.

15. The system of claim 14, wherein determining the anonymized address for the first cell comprises:
determining that the number of address points in the first cell is greater than or equal to a specified number of address points; and
in response to determining that the number of address points in the first cell is greater than or equal to a specified number of address points, retrieving, from the data storage, the generated anonymized address for the first cell.

16. The system of claim 14, wherein determining the anonymized address for the first cell comprises:
determining that the number of address points in the first cell is less than a specified number of address points; and
generating an updated anonymized address for the first cell, the generating the updated anonymized address comprising:
traversing the hierarchical structure of address components for address points of selected cells comprising the first cell and each cell neighboring the first cell to determine address components that are different between address points in the selected cells;
for each address component that is different between address points in the selected cells, generating an anonymized address component using a common prefix for the address component or a combination of address components;
generating the updated anonymized address for the first cell comprising at least one anonymized address component; and
wherein providing the anonymized address for the first cell to the computing device as the address of the location comprises providing the updated anonymized address.

17. The system of claim 10, further comprising:
determining geographical coordinates for a specified location;
determining that the first cell comprises the geographical coordinates;
providing, to a computing device, an anonymized address of the first cell to be displayed on the computing device as the specified location within a circle corresponding to a size of the first cell.

18. The system of claim 10, further comprising:
determining geographical coordinates for a specified location;
determining that the first cell comprises the geographical coordinates;
selecting a center point within the first cell; and
providing, to a computing device, the location of the center point within the cell to be displayed on the computing device as the specified location within a circle corresponding to a size of the first cell.

19. A non-transitory computer-readable medium comprising instructions stored thereon that are executable by at least one processor to cause a computing device to perform operations comprising:
generating a plurality of cells representing a geographical area, each cell of the plurality of cells comprising a plurality of address points representing addresses in the cell;
normalizing each address corresponding to each address point into a hierarchical structure of address components;
traversing a hierarchical structure of address components for address points in a first cell of the plurality of cells to determine address components that are different between address points in the first cell;
for each address component that is different between address points in the first cell, generating an anonymized address component using a common prefix for the address component or a combination of address components;
generating an anonymized address for the first cell comprising at least one anonymized address component; and
storing the anonymized address for the first cell to a data storage.

20. The non-transitory computer-readable medium of claim 19, wherein generating the anonymized address component using the common prefix for the address component comprises:
determining the common prefix for the address component; and
replacing characters after the common prefix with one or more predefined characters to generate the anonymized address component.
